(19) United States
(12) Patent Application Publication
(10) Pub. No.: US 2026/0159337 A1
(43) Pub. Date: Jun. 11, 2026

(54) MODULAR COLLABORATIVE ROBOTIC SYSTEM

(71) Applicant: EIS Equipment Integration Solutions Ltd., Las Vegas, NV (US)

(72) Inventor: Joshua Watson, Las Vegas, NV (US)

(73) Assignee: EIS Equipment Integration Solutions Ltd., Las Vegas, NV (US)

(21) Appl. No.: 19/181,486

(22) Filed: Apr. 17, 2025

Related U.S. Application Data
(60) Provisional application No. 63/636,261, filed on Apr. 19, 2024.

(51) Int. Cl. B65G 47/90

(52) U.S. Cl. CPC B65G 47/902

(57) ABSTRACT

A modular collaborative robotic system is disclosed. The system comprises a cobot and a modular conveyor attached to the cobot, wherein the cobot is programmed to operate in a working envelope relative to the conveyor, wherein the cobot and attached conveyor are adapted to be relocated without affecting the working envelope relative to the conveyor.

### CROSS-REFERENCE TO RELATED APPLICATIONS

This application claims priority to and the benefit of U.S. Provisional Patent Application No. 63/636,261 filed on Apr. 19, 2024 and entitled, “Collaborative Robotic Palletizing System,” which is incorporated herein by reference in its entirety.

### BACKGROUND

Collaborative robots, also known as cobots, are often used in shared workspaces with humans, performing repeatable tasks such as assembly, insertion, palletizing, and other high frequency tasks. A cobot may be located at a single location, or workspace, and the cobot may be programmed for operation within a defined programmed working envelope. This may work as long as the cobot is to be utilized at the single location, such as a single location on a floor of a manufacturing or packaging facility. However, if it is desired to move the cobot to be utilized at one or more other locations, absent such additional complexity such as machine vision, the cobot typically would need to be reprogrammed, to redefine its programmed working envelope relative to its new location.

The present invention is provided to address this and other problems.

### SUMMARY

It is an object of the present invention to provide a modular system including a portable cobot which may be readily repositioned, such as about a manufacturing or packaging facility, without a requirement for reprogramming.

The cobot may be attached to a portable modular conveyor. The cobot may be programmed such that its programmed working envelope is defined relative to the modular conveyor. Thus, the cobot's programmed working envelope moves with the modular conveyor/cobot pair. Therefore, for example, the modular conveyor/cobot pair may be positioned to receive and palletize packages streaming down a first production line conveyor and, as needed, be moved to receive and palletize packages streaming down a second production line conveyor, without any reprogramming of the cobot.

This and other objectives and advantages may become apparent from the following description taken in conjunction with the accompanying Figures.

### DESCRIPTION OF THE FIGURES

FIG. 1 is an end view of a cobot positioned on a base, in accordance with one embodiment of the present invention;

FIG. 2 is a side view of the cobot of FIG. 1, in combination with a portable conveyor, forming a cobot/conveyor pair in accordance with the present invention;

FIG. 2A is a detail of “A” of FIG. 2;

FIG. 3 is an isometric view of the cobot/conveyer pair of FIG. 2;

FIG. 4 is an isometric view of the cobot/conveyer pair of FIG. 2;

FIG. 5 is an end view of the cobot/conveyer pair of FIG. 2, also showing pallets and extended outriggers in accordance with the present invention;

FIG. 6 is a side view of the cobot/conveyer pair of FIG. 2, also showing pallets and extended outriggers in accordance with the present invention;

FIG. 7 is a top view of the cobot/conveyer pair of FIG. 2, also showing pallets and extended outriggers in accordance with the present invention;

FIG. 8 is an isometric view of the cobot/conveyer pair of FIG. 2, also showing pallets and extended outriggers in accordance with the present invention; and

FIG. 9 is another isometric view of the cobot/conveyer pair of FIG. 2, also showing pallets and extended outriggers in accordance with the present invention.

### DESCRIPTION OF THE PREFERRED EMBODIMENT

While this invention is susceptible of embodiments in many different forms, there will be described herein in detail, a specific embodiment thereof, with the understanding that the present disclosure is to be considered an exemplification of the principles of the invention and is not intended to limit the invention to the specific embodiment illustrated.

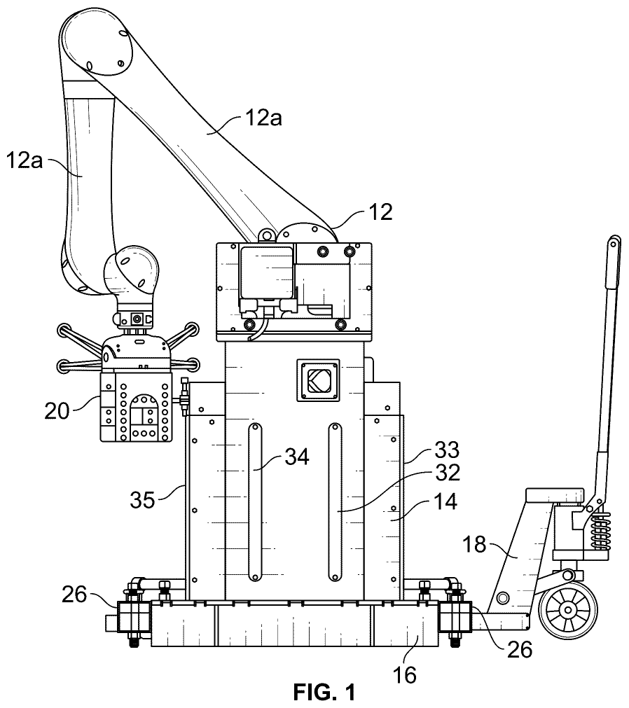

A collaborative robot, or cobot, 12, as may be utilized in accordance with the present invention, is illustrated in FIG. 1. The cobot 12 may be a conventional Fanuc CRX series robot, such as the CRX 25iA robot, sold by Fanuc Corporation of Japan. The cobot 12 may include a multi-segmented moveable arm 12a, terminating with an end-of-arm tool (EOAT), or end effector 13, depending on the desired task for the cobot 12.

The cobot 12 may be mounted on a conventional pedestal, which pedestal may be located within a housing 14, supported on a base 16. Control equipment for the cobot 12 may also be located within the housing 14. The cobot 12, including the pedestal, control equipment, housing 14, base 16, and associated components, will herein be referred to as a cobot module 17.

The cobot module 17 may be repositioned, such as about a manufacturing/assembly facility, by a hand truck 18, forklift (not shown), or the like.

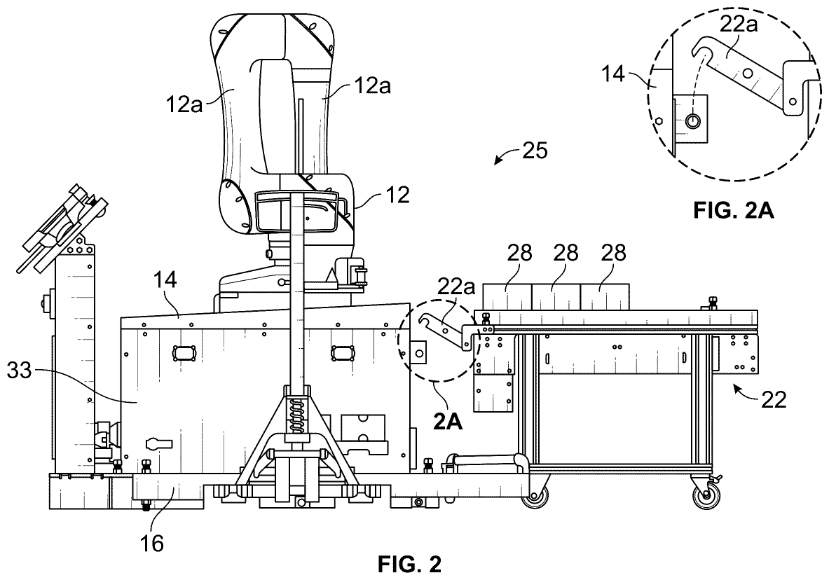

The cobot module 17 in conjunction with a modular conveyor 22. is illustrated in FIG. 2. The portable conveyor 22 may receive packages 24, such as from a discharge end of a production line conveyor (not shown). As discussed below, in the present embodiment, the packages 24 may be received from the discharge end of the production line conveyor, which packages 24 may then be palletized by the cobot 12.

The modular conveyor 22 may be removably attached to the cobot module 17 by a conveyor latch 22a, as detailed in FIG. 2A, which maintains the modular conveyer 22 in a fixed position relative to the cobot module 17. The modular conveyor 22 in combination with the cobot module 17 will be collectively referred to herein as a palletizing system 25.

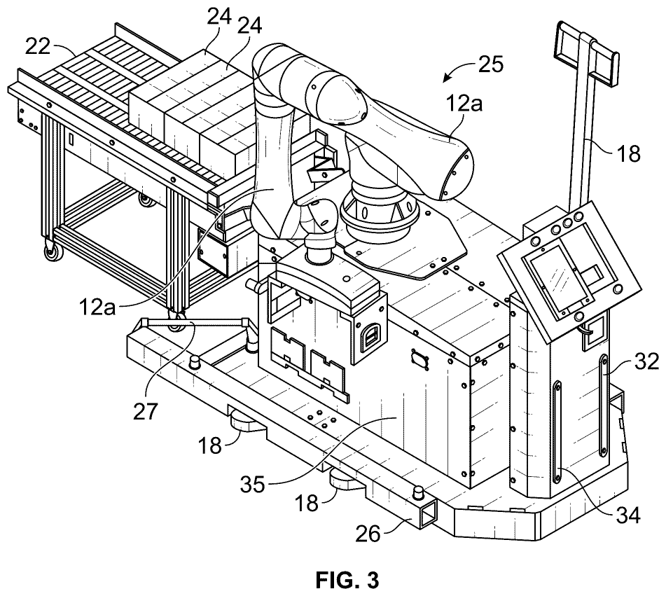

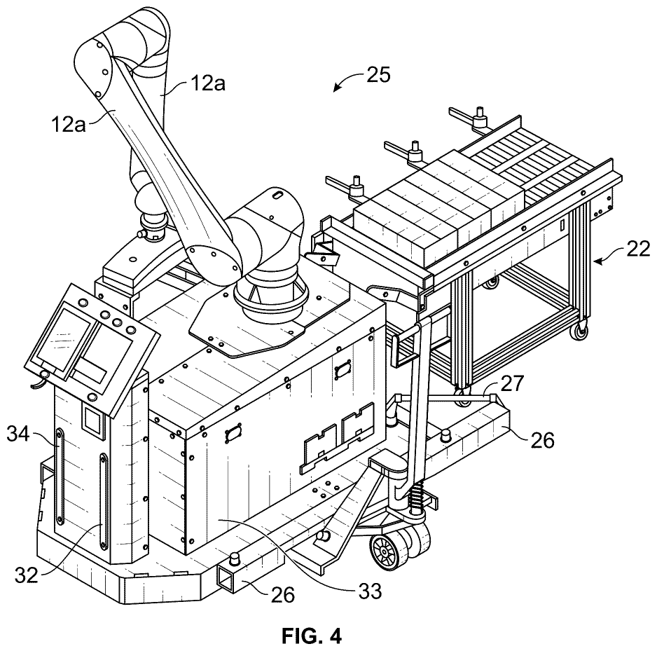

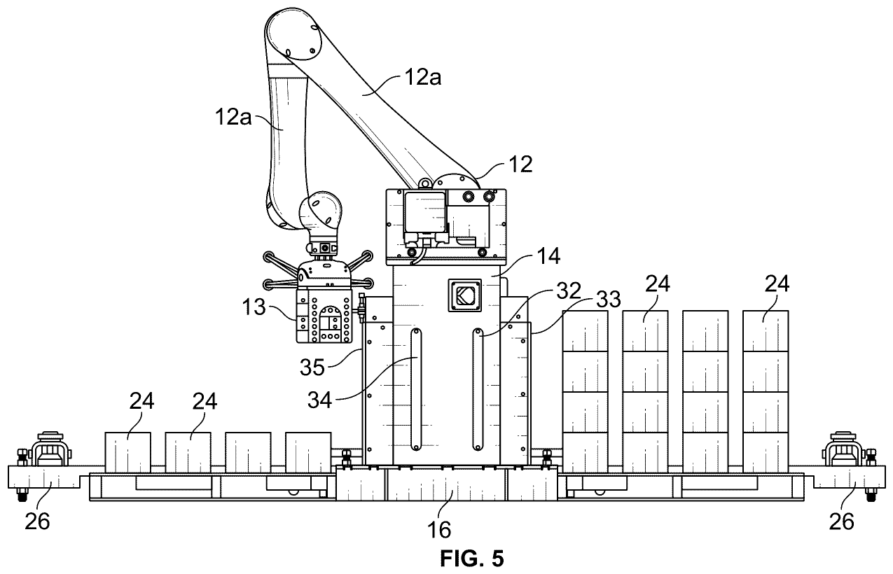

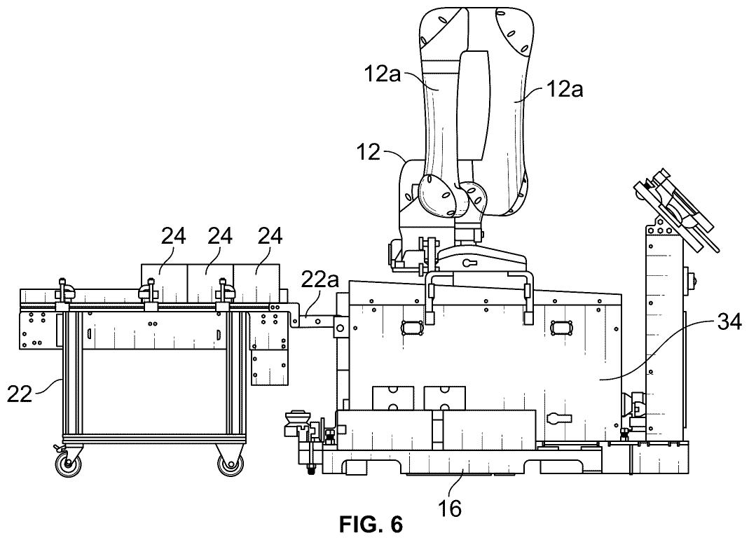

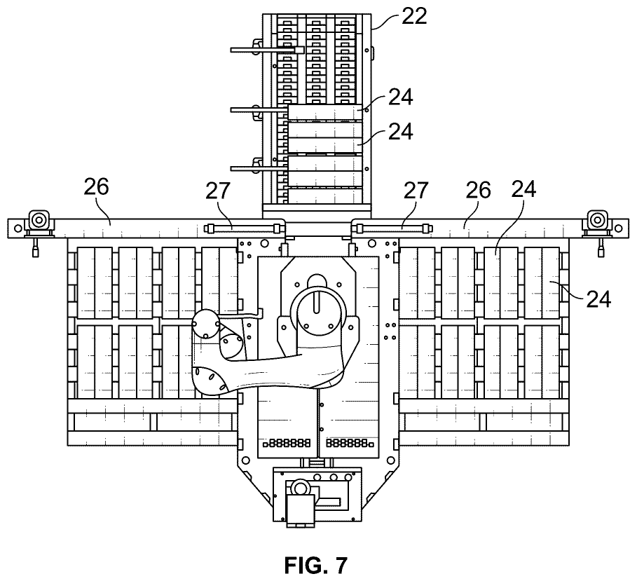

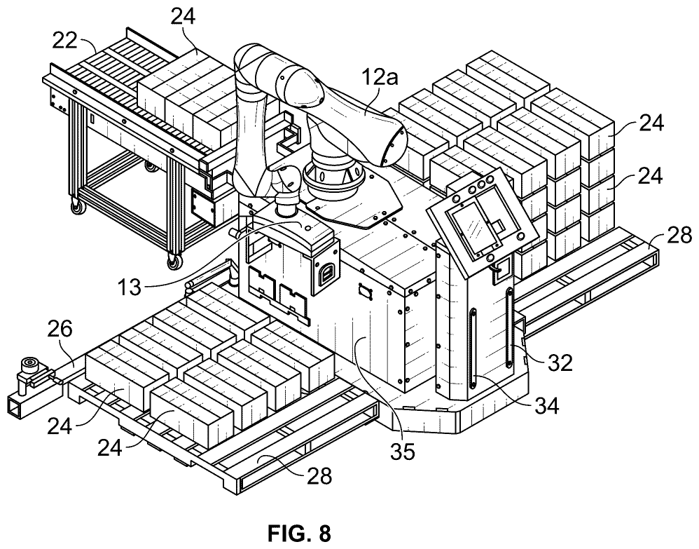

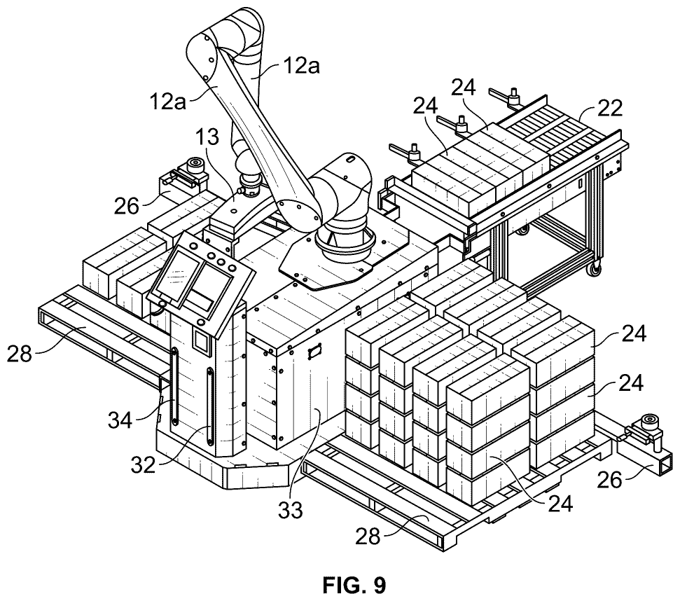

The base 16 may include two retractable outriggers 26, shown in their retracted position in FIGS. 3 and 4, and shown in their extended positions in FIGS. 5, 7, 8 and 9. Latching arms, or handles, 27 may be provided to respectively latch each of the outriggers 26 in their respective retracted and extended positions. The outriggers 26 may provide stability for the cobot module 17. The outriggers 26 may also define the position for placement of pallets 28, butted against their respective side of the base 16 and respective one of the outriggers 26, onto which the cobot 12 may palletize the packages 24 from the modular conveyor 22.

In accordance with the present invention, the cobot 12 may be programmed to define its programmed working envelope to include the portable conveyor 22, attached to the cobot module 17, and the pallets 22, positioned per the extended outriggers 26. As such, the cobot 12 my pick up the packages 24 on the portable conveyor 22 and palletize the packages 24 onto the positioned pallets 28. Because the programmed working envelope may be defined relative to the palletizing system 25, the palletizing system may be relocated about a manufacturing/packaging facility (e.g., receiving packages from different production line conveyors) without a need for further programming.

It is contemplated the housing 14 may include visual annunciation of operating status. As illustrated in FIGS. 3 and 4, the housing 14 may include a right-side LED strip 32, a right-side LED panel 33, a left side LED strip 34 and a left side LED panel 35. The right-side LED strip 32 and the right-side LED panel may provide a visual indication of the cobot's 12 right side operation, and the left side LED strip 34 and the left side LED panel may provide a visual indication of the cobot's 12 left side operation.

It is further contemplated a laser scanner safety package may be added, such as for speeds exceeding collaborative speed (1 m/s). The package may consist of three laser scanners mounted at the end of each outrigger and between the operator console and the main robot frame. (see FIGS. 2 and 5)

It is still further contemplated to include a traceability and data management package (Tarsier Series). EIS in-house software may be paired with barcode readers and or machine vision system to track each box individually prior to being palletized.

It is still further contemplated to include a case coding system. A label applicator or direct to box print option may be provided to allow for labeling and marking each box. This option may require a two-meter positioning conveyor, rather than a one meter.

It is to be understood that this disclosure is not intended to limit the invention to any particular form described, but to the contrary, the invention is intended to include all may be modifications, alternatives and equivalents falling within the spirit and scope of the invention.

I claim:

1. A modular collaborative robotic system comprising;
a cobot; and
a modular conveyor attached to the cobot, wherein the cobot is programmed to operate in a working envelope relative to the conveyor, wherein the cobot and attached conveyor are adapted to be relocated without affecting the working envelope relative to the conveyor.

2. The system of claim 1, wherein the conveyor is releasably attached to the cobot in a fixed position relative to the cobot.

3. The system of claim 1 wherein the cobot and the conveyor are mobile.

4. The system of claim 3, wherein the cobot and the conveyor are adapted to be repositioned about a factory floor.

5. The system of claim 1, wherein the cobot is mounted on a base and the base includes a stabilizing outrigger.

6. The system of claim 5, wherein the outrigger is retractable.

7. The system of claim 5 wherein the outrigger defines a location within the working envelope to place a pallet relative to the cobot.

8. The system of claim 7, wherein the cobot is adapted to pick items arriving on the conveyor and place the picked packages onto the pallet.

9. The system of claim 1 including visual annunciation of operating status of the cobot.

10. A modular collaborative robotic system for palletizing items, the system comprising;
a cobot mounted on a base, wherein the base includes a stabilizing outrigger, the outrigger adapted to define a pallet locating area to position a pallet relative to the cobot; and
a modular conveyor attached to the cobot, wherein the cobot is programmed to operate in a working envelope including the conveyor, wherein the cobot is programmed to operate in a working envelope including the conveyor and the pallet locating area, the conveyor being adapted to convey items to the cobot to be placed on a pallet disposed in the pallet locating area.

11. The system of claim 10, wherein the cobot and attached conveyor are adapted to be relocated without affecting the working envelope relative to the conveyor.

12. The system of claim 10, wherein the conveyor is releasably attached to the cobot in a fixed position relative to the cobot.

13. The system of claim 10, wherein the cobot and the conveyor are adapted to be repositioned about a factory floor.

14. The system of claim 10, wherein the outrigger is retractable.

15. The system of claim 10 including visual annunciation of operating status of the cobot.
